(19) United States
(12) Patent Application Publication
(10) Pub. No.: US 2025/0138190 A1
(43) Pub. Date: May 1, 2025

(54) 4D FMCW LiDAR Sensor with Ultra-High Velocity Resolution

(71) Applicant: National Central University, Taoyuan City (TW)

(72) Inventors: Jin-Wei Shi, Taoyuan City (TW); Chia-Chien Wei, Taoyuan City (TW)

(21) Appl. No.: 18/403,263

(22) Filed: Jan. 3, 2024

(30) Foreign Application Priority Data
Oct. 31, 2023 (TW) 112141749

(51) Int. Cl. G01S 17/58; G01S 7/4911; G01S 7/4913; G01S 7/493

(52) U.S. Cl. CPC G01S 17/58; G01S 7/4911; G01S 7/4913; G01S 7/493

(57) ABSTRACT

A four-dimensional (4D) light-detection-and-ranging sensor using frequency modulated continuous wave is provided with an ultra-high velocity resolution. At a transmitting terminal, the hybrid waveform of a driving laser is used to minimize the phase noise generated by a distributed-feedback laser during wavelength scanning. The hybrid waveform is obtained by combining direct-current signal (not modulated) and alternating-current (AC) signal. The AC signal is a predistorted triangle or AC waveform for extracting location. The continuous wave (CW) extracts velocity. At a receiving terminal, a radar radio-frequency receiver is combined with an avalanche photodiode (APD) with multiple layers accumulated in series to obtain excellent responsivity and saturated current. The mixed waveform coordinated with the APD prevents Doppler shift frequency from being contaminated by low-frequency flicker noise. Thus, a good-quality 4D image is provided; and the use of the APD improves the pixel contrast between the object and background.

### TECHNICAL FIELD OF THE INVENTION

The present invention relates to a four-dimensional (4D) light-detection-and-ranging (LIDAR) sensor; more particularly, to directly providing a real-time 4D image at a time, where a hybrid waveform is obtained by combining direct current (DC) signal (not modulated) and alternating-current (AC) signal for a 4D measurement of simultaneously acquiring the position and velocity of a target.

### DESCRIPTION OF THE RELATED ARTS

Frequency modulated continuous wave (FMCW) radar has many excellent industrial applications, including automotive or military sensing, hand gesture recognition (HGR), and velocity measurement for non-contact vital sign monitoring (VSM). Compared with other radar technologies, the FMCW radar has a unique advantage, which is able to obtain instantaneous velocity information of object(s) and eliminate dead time during operation. In order to meet the requirements of HGR and VSM applications, there are great needs of FMCW radar detection with extremely high velocity sensitivity. However, it is still a challenge to obtain real-time 4D (three-dimensional (3D)+velocity) images based on FMCW radar solutions with small antenna sizes. FMCW LIDAR combines the FMCW radar structure with additional electro-optical (EO) and optoelectronic (OE) conversion modules, which is proven to be one of the most effective solutions for achieving this goal. By using a miniaturized FMCW LIDAR module with compact optical components inside, a 4D image can be obtained at a light wavelength of 1.55 micrometers (μm). Besides, these LiDAR images usually exhibit better angular resolutions than FMCW radar images in terms of azimuth and elevation. Moreover, when the center frequency is raised from radio frequency to light wave, the high-speed sensitivity is also expected to be improved. Commercially available laser vibrometers have demonstrated ultrahigh-speed sensitivity (close to nanometer per second (nm/sec)). Nevertheless, with the vibrometers, 3D contours having absolute distance information still cannot be simply obtained from the interference signal of a static laser. For realizing a 4D FMCW LIDAR, a wavelength scanning laser used as a light source is indispensable. In recent years, the demands for 4D FMCW LIDAR, which has speed sensitivity comparable to those of vibrometers and can simultaneously and instantly measure physical parameters and dynamic fine displacements of civil structures, increase dramatically. One of the main traditional challenges for 4D FMCW LIDAR in meeting the above applications is how to make the instantaneous linewidth of a wavelength scanning laser to be as narrow as that of a high-performance static laser. In addition, the phase noise and nonlinearity of the wavelength scanning laser are usually greater than those of the scanning radio-frequency (RF) source at the FMCW radar transmitter side, which severely limits the ability on resolving the tiny Doppler shifts required for high-speed sensitivity performance.

Given that traditional 4D images are captured by using charge-coupled device (CCD) cameras, laser light is used to hit the required location for acquiring the vibration velocity at the location. The portion of LIDAR is measured by using an FMCW predistorted triangular wave only. This principle can be applied to the 3D measurement of distance image and also to one-dimensional (1D) measurement of vibration, which is mainly for the speed of 2D images+1D thus considered as a 3D technology; in other words, the conventional technology does not directly provide 4D video in one go. Hence, the prior arts do not fulfill all users' requests on actual use.

### SUMMARY OF THE INVENTION

The main purpose of the present invention is to combine an advanced radar RF receiver of FMCW, a state-of-the-art LiDAR APD, and a novel pre-programmed laser-driving waveform (hybrid waveform of DC signal+AC signal) to obtain a 4D LIDAR sensor achieving an ultra-high velocity resolution.

To achieve the above purpose, the present invention is a 4D FMCW LIDAR sensor with ultra-high velocity resolution, comprising a wavelength scanning laser and a radar RF receiver, where the wavelength scanning laser is modulated by an electrical hybrid waveform composed of a non-modulated direct-current (DC) signal and an alternating-current (AC) signal to drive a laser thereby, and minimizes phase noise generated by distributed-feedback laser during wavelength scanning; the radar RF receiver receives the hybrid waveform combined with DC signal and AC signal of wavelength scanning laser and combined with an APD having a plurality of multiplication layers accumulated in series; and, on detecting, a velocity of a target is obtained by using the DC signal and a location of the target is obtained by using the AC signal to obtain the location and velocity of the target at a time period. Accordingly a novel 4D FMCW LIDAR sensor with ultra-high velocity resolution is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the block view showing the preferred embodiment according to the present invention;

FIG. 2 and FIG. 3 are the views showing the four-dimensional (4D) images obtained by using the novel hybrid waveform and the traditional pure frequency modulated continuous wave (FMCW), respectively;

FIG. 4 and FIG. 5 are the views showing the 4D images obtained by using the avalanche photodiode (APD) and the PIN photodiode (PD), respectively;

FIG. 6 and FIG. 7 are the views showing the 4D images obtained by using the APD and the PIN PD at the moving velocity of 0.005 millimeters per second (mm/s), respectively; and

FIG. 8 and FIG. 9 are the views showing the images obtained by using the scanning laser of the hybrid waveform and the static laser at the moving velocity of 0.005 mm/s, respectively.

### DESCRIPTION OF THE PREFERRED EMBODIMENT

The following description of the preferred embodiment is provided to understand the features and the structures of the present invention.

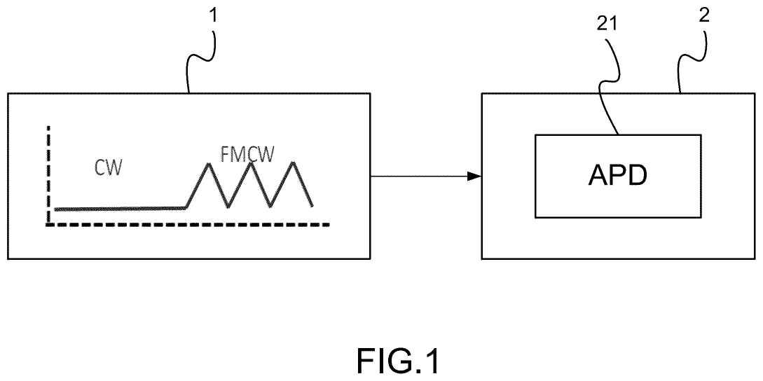

Please refer to FIG. 1 to FIG. 9, which are a block view showing a preferred embodiment according to the present invention; views showing 4D images obtained by using a novel hybrid waveform and a traditional pure FMCW, respectively; views showing 4D images obtained by using an APD and a PIN PD, respectively; views showing 4D images obtained by using the APD and the PIN PD at a moving velocity of 0.005 mm/s, respectively; and views showing images obtained by using a scanning laser of the hybrid waveform and a static laser at the moving velocity of 0.005 mm/s, respectively. As shown in the figures, the present invention is a 4D FMCW light-detection-and-ranging (LiDAR) sensor with ultra-high velocity resolution, comprising a wavelength scanning laser 1; and a radar radio-frequency (RF) receiver 2 connected to the wavelength scanning laser 1.

As shown in FIG. 1, at a transmitting terminal, as compared with a traditional detection that uses FMCW signal alone, the wavelength scanning laser 1 has a novel hybrid waveform (CW+FMCW) for driving a laser to minimize phase noise generated by distributed feedback (DFB) laser during wavelength scanning, where the hybrid waveform is obtained by combining a continuous wave (CW) signal and an FMCW signal.

At a receiving terminal, the radar RF receiver 2 and an APD 21 with multiplication layers (M-layer) accumulated in series are combined to form a detection circuit. On detecting, by using the FMCW signal as a predistorted triangle waveform, the location of a target is extracted and the velocity of the target is extracted by the CW signal to measure the location and velocity of the target at a time period. Hence, the location of a target is acquired together with its velocity. Thus, a novel 4D FMCW LIDAR sensor with ultra-high velocity resolution is obtained.

The following descriptions of the states-of-use are provided to understand the features and the structures of the present invention.

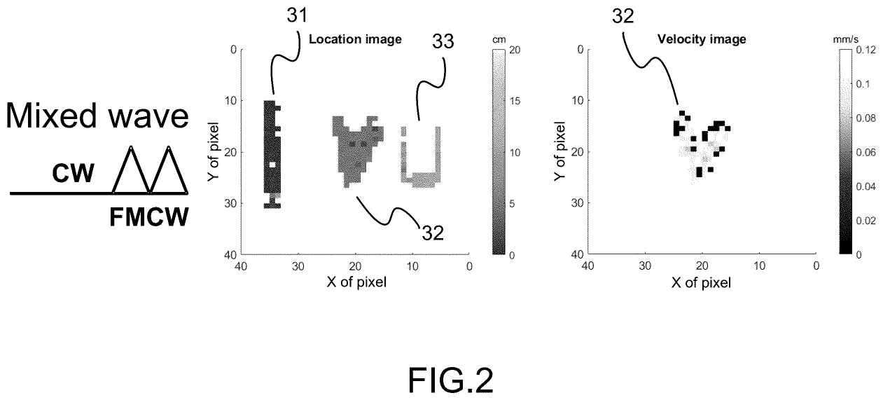

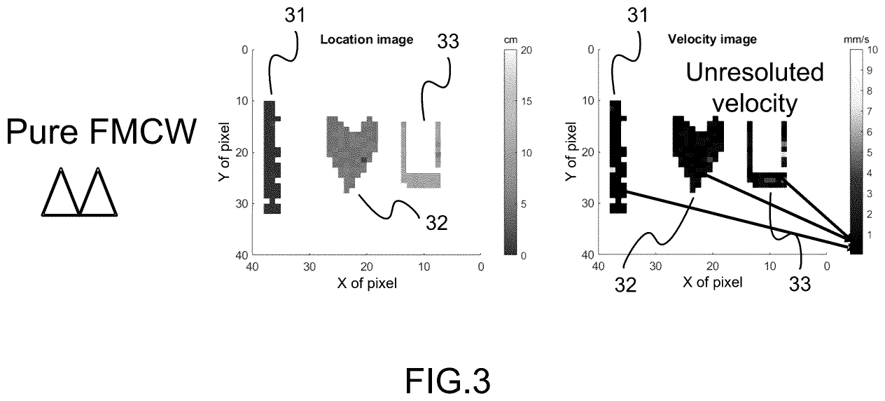

In a state-of-use, the present invention uses objects having a first, a second, and a third shapes 31,32,33, which are made of polystyrene foam and wrapped with reflective tape, for testing and for simultaneously detecting distance and velocity. The present invention places the object having the second shape 32 on an electric linear platform moving at a given velocity, where the object having the second shape 32 is in a moving state and the objects having the first and third shapes 31,33 remain stationary. On testing with a detection circuit having an APD combined with a radar RF receiver while the velocity of the object having the second shape 32 is 0.1 mm/s, the 4D image for the hybrid waveform according to the present invention and that for a traditional FMCW-alone waveform are compared, as respectively shown in FIG. 2 and FIG. 3. In the location images, both the image for the present invention (FIG. 2) and that for the prior art (FIG. 3) contain symbols having the first, the second, and the third shapes 31,32,33. However, in the velocity images, the image for the prior art (FIG. 3) contains figures for predistorted triangle wave only. Therein, only the object having the second shape 32 has a velocity change of vibration and the velocity change at the locations of the other objects having the first and third shapes 31,33 are zero which should not appear, but the image for the prior art shows all symbols having the first, the second, and the third shapes 31,32,33. It means that the prior art does not detect the differences in velocity and, therefore, the result obtained is wrong. Meanwhile, the present invention uses the hybrid waveform and only displays the symbol having the second shape 32 (FIG. 2). Accordingly, the present invention adopts the driving laser of the hybrid waveform (CW+FMCW) to accurately detect out the object having the second shape 32 on vibrating only, which shows a higher velocity resolution than the driving laser using FMCW alone.

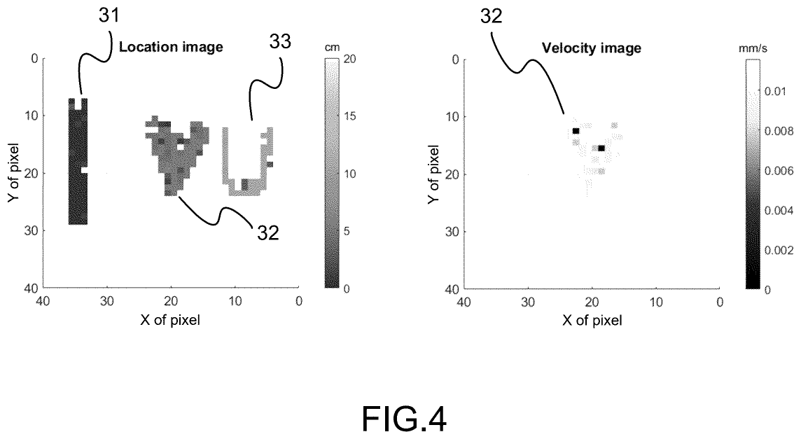

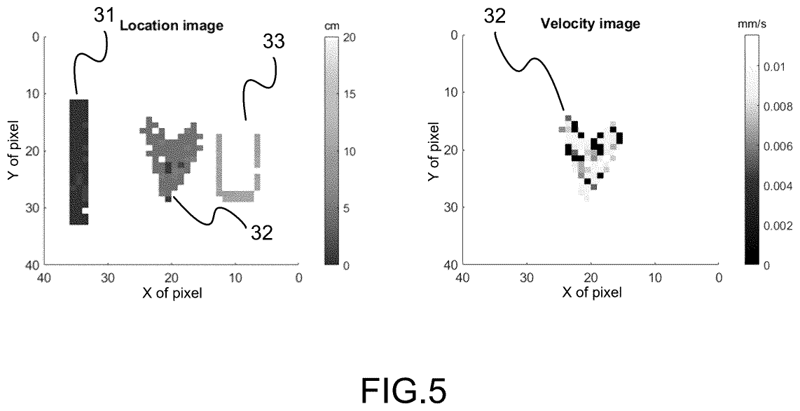

In a state-of-use, the present invention uses a purpose-made APD with M-layers accumulated in series to replace commercial PIN PD for further improving velocity resolution and, thus, reducing the phase noise and amplitude noise in signals during detection. FIG. 4 and FIG. 5 show 4D images measured by using APD and PIN PD with an object having a second shape 32 moving at a velocity of 0.01 mm/s, respectively. As a result shows, as compared with that for the PIN PD shown in FIG. 5, the velocity for the APD shown in FIG. 4 is more accurately measured at a moving velocity slower than 0.01 mm/s for achieving better performance. Hence, APD displays 4D image with better quality than commercial PIN PD.

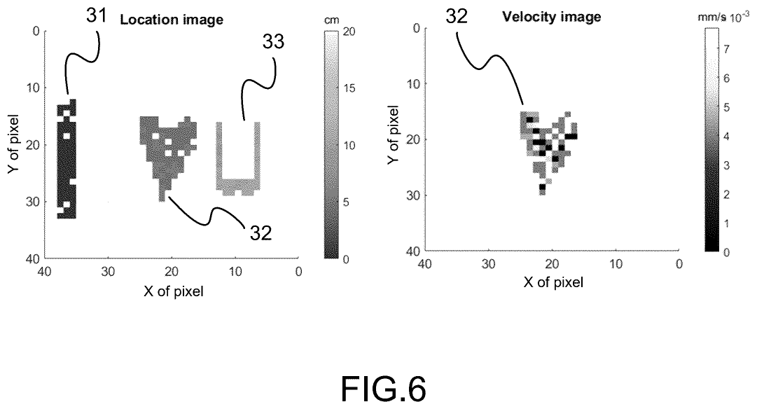

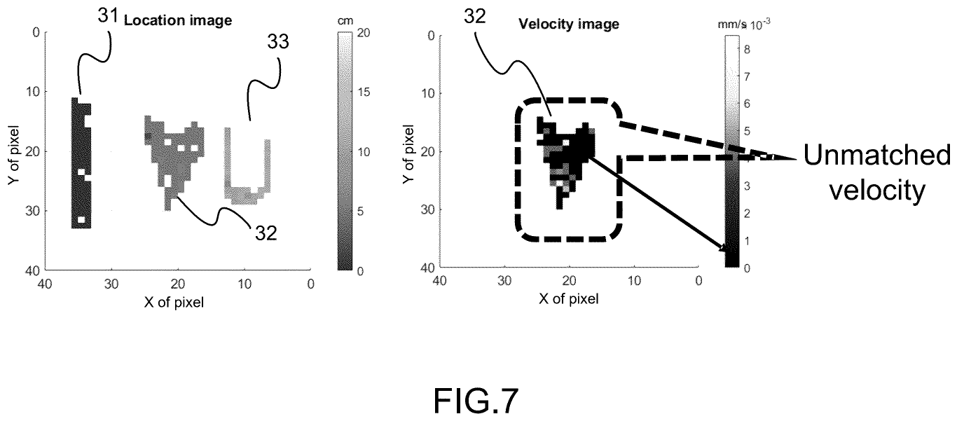

In a state-of-use as shown in FIG. 6 with FIG. 7 referenced, the object having the second shape 32 moves at an extremely slow velocity of 0.005 mm/s to process comparison based on a 4D image for APD using hybrid waveform and that for PIN PD, respectively. As a result shows, when the moving velocity is reduced to as slow as 0.05 mm/s, error in velocity measured for the APD as shown in FIG. 6 is even smaller as a better result. Compared with 0.01 mm/s for the PIN PD as shown in FIG. 7, the APD shown in FIG. 6 shows higher velocity resolution, which can be up to 0.005 mm/s.

Compared with a referenced LiDAR system using traditional RF oscillator and PIN PD at receiving terminal, the present invention uses a design of a hybrid waveform (CW+FMCW) for the APD. Therein, DC signal is further up-converted with sine-wave modulation to prevent Doppler shift frequency from being contaminated by low-frequency flicker noise for providing a good-quality 4D image of slow-moving (0.005 mm/sec) object. The use of the high-performance APD also improves the pixel contrast between the object and background.

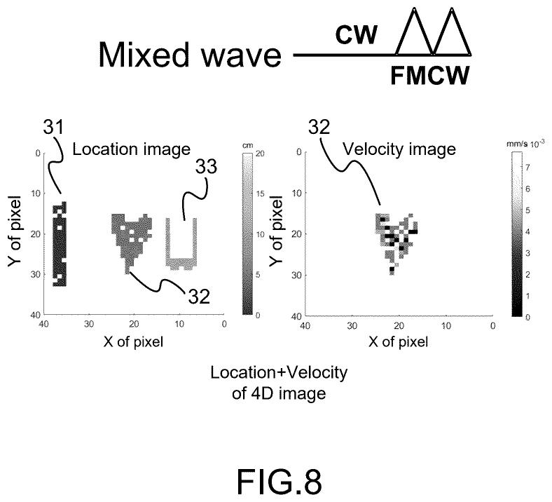

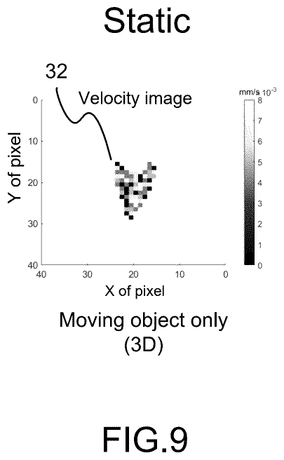

In a state-of-use as shown in FIG. 8 with FIG. 9 referenced, when the moving velocity of the object having the second shape 32 is 0.005 mm/s, an image obtained by using a scanning laser based on the hybrid waveform and that obtained by using a static laser are compared. It is found that, in a result of comparing FIG. 8 for the hybrid waveform combining CW+FMCW and FIG. 9 for CW-alone (not modulated), both cases exhibit very similar velocity-image quality. That is, the velocity resolution for the hybrid waveform and that for the static waveform are the same. As the result shows, the 4D FMCW LIDAR according to the present invention provides a velocity resolution comparable to that of a laser vibrometer, where the laser vibrometer is usually driven by a static laser operated with a CW waveform.

Table 1 shows the current progresses in 4D FMCW LIDAR research. As shown in Table 1, compared with On-chip Silicon Photonic Platform (75 mm/s), Silicon Photonic Slow-Light Grating (400 mm/sec), Si-Photonic crystal beam scanners (19 mm/s), and Phase-diversity coherent detection, the present invention uses a hybrid waveform of CW+FMCW and a detection circuit with a radar RF receiver using APD, where a velocity resolution thus achieved (0.05 mm/s) is the highest currently available and shows what the present invention provides has the strongest capability in resolution.

TABLE 1

| Velocity | | |
|---|---|---|
| measured | | |
| (mm/s) | Technology used | Referance |
| 75 | On-chip Silicon | C V. Poulton, et. al, “Coherent |
| | Photonic Platform | solid-state LiDAR with silicon |
| | | photonic optical phased arrays,” |
| | | Opt. Lett. 42, 4091-4094 (2017). |
| 400 | Silicon Photonic | T. Baba et al., “Silicon Photonics |
| | Slow-Light Grating | FMCW LiDAR Chip With a |
| | | Slow-Light Grating Beam |
| | | Scanner,” in IEEE Journal of |
| | | Selected Topics in Quantum |
| | | Electronics, vol. 28, no. 5: |
| | | LiDARs and Photonic Radars, pp. |
| | | 1-8, September-October 2022. |
| 19 | Si-Photonic crystal | S. Suyama, et al., “Doppler |
| | beam scanners | velocimeter and vibrometer FMCW |
| | | LiDAR with Si photonic crystal beam |
| | | scanner,” Opt. Express, vol. 29, no |
| | | 19, pp. 30727-30734, September |
| | | 2021. |
| 1500 | Phase-diversity | Z. Xu, et al., “FMCW LiDAR Using |
| | coherent detection | Phase-Diversity Coherent Detection |
| | | to Avoid Signal Aliasing,” IEEE |
| | | Photon. Technology Letter., vol. 31, |
| | | no. 22, pp. 1822-1825, November |
| | | 2019. |
| 0.005 | Hybrid waveform | The present invention |
| | using CW + FMCW, | |
| | together with | |
| | detection circuit of | |
| | radar RF receiver | |
| | using APD | |

Accordingly, the present invention combines an advanced radar RF receiver of FMCW, a state-of-the-art LIDAR APD, and a novel pre-programmed laser-driving waveform (hybrid waveform of CW+FMCW) to achieve an ultra-high velocity resolution.

To sum up, the present invention is a 4D FMCW LIDAR sensor with ultra-high velocity resolution, where a real-time 4D image is directly provided at a time; and a hybrid waveform is obtained by combining DC signal (not modulated) and AC signal for a 4D measurement of simultaneously acquiring the location and velocity of a target.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A four-dimensional (4D) frequency-modulated-continuous-wave (FMCW) light-detection-and-ranging (LiDAR) sensor with ultra-high velocity resolution, comprising
a wavelength scanning laser,
wherein said wavelength scanning laser is modulated by an electrical hybrid waveform composed of a non-modulated direct-current (DC) signal and an alternating-current (AC) signal; and,
a radar radio-frequency (RF) receiver,
wherein said radar RF receiver receives signal of said wavelength scanning laser and, on detecting, a velocity of a target is obtained by using said DC signal and a location of said target is obtained by using said AC signal to obtain said location and said velocity of said target at a time period.

2. The sensor according to claim 1,
wherein said DC signal is a continuous wave (CW) signal; and said AC signal is a frequency modulated continuous wave (FMCW) signal.

3. The sensor according to claim 1,
wherein said AC signal is selected from a group consisting of a predistorted triangle waveform and a predistorted AC waveform.

4. The sensor according to claim 1,
wherein said DC signal is further up-converted with sine-wave modulation.

5. The sensor according to claim 1,
wherein said radar RF receiver is combined with an avalanche photodiode (APD) having a plurality of multiplication layers accumulated in series.
